(19) United States
(12) Patent Application Publication
(10) Pub. No.: US 2024/0127203 A1
(43) Pub. Date: Apr. 18, 2024

(54) TRANSACTION MANAGEMENT METHOD, SYSTEM AND PROGRAM

(71) Applicants: Yoshimitsu KAGIWADA, Ashigarakamigun Matsudamachi (JP); KEYSOFT, INC., Ashigarakamigun Matsudamachi (JP)

(72) Inventor: Yoshimitsu KAGIWADA, Ashigarakamigun Matsudamachi (JP)

(73) Assignees: Yoshimitsu KAGIWADA, Ashigarakamigun Matsudamachi (JP); KEYSOFT, INC., Ashigarakamigun Matsudamachi (JP)

(21) Appl. No.: 18/393,592

(22) Filed: Dec. 21, 2023

Related U.S. Application Data
(63) Continuation of application No. PCT/JP2022/025420, filed on Jun. 24, 2022.

(30) Foreign Application Priority Data
Jun. 24, 2021 (JP) 2021-105263

(51) Int. Cl. G06Q 20/10; G06Q 20/14

(52) U.S. Cl. CPC G06Q 20/102; G06Q 20/14

(57) ABSTRACT

One or more embodiments may include a computer that performs operations comprising: searching a billing information corresponding to the purchaser identifier and a deposit amount indicated in a deposit notification; extracting a chain identifier in the searched billing information; setting payment flags of billing information including a chain identifier that is common to the extracted chain identifier as payable; reading the billing source identifier, the billing recipient identifier, and the billing amount from the billing information which the payment flags are set to payable; reading the deposit account information associated with the vendor identifier corresponding to the read billing source identifier, and the withdrawal account information associated with the vendor identifier corresponding to the read billing recipient identifier; generating transfer instruction information including the deposit account information, the withdrawal account information and a transfer amount based on the billing amount; and sending the instruction information to a financial institution.

### CROSS REFERENCE TO RELATED APPLICATIONS

This application is a continuation application of International Application No. PCT/JP2022/025420, filed on Jun. 24, 2022, which claims priority based on the Article 8 of Patent Cooperation Treaty from prior Japanese Patent Application No. 2021-105263, filed on Jun. 24, 2021, the entire contents of which are incorporated herein by reference.

### TECHNICAL FIELD

The disclosure relates to a transaction management system, and in particular to a transaction management system that automates transactions between multiple vendors.

The applicant has obtained patents that automate the generation of invoice slips and delivery slips generated by transactions between multiple vendors (Japanese Patent Publication No. 2012-178147 (Patent Document 1), Japanese Patent No. 5887965 (Patent Document 2), Japanese Patent No. 6675598 (Patent Document 3), the entire contents of which are incorporated herein by reference.

On the other hand, it may be preferrable to automate the payments generated by transactions between multiple vendors and recording of ledgers related to payments.

One or more embodiments may aim to automate payments generated by transactions between multiple vendors. It also aims to automate the recording of ledgers related to payments among multiple vendors.

### SUMMARY

One or more embodiments may include the following configuration. That is, one or more embodiments may include a billing information memory that stores a plurality of related billing information that occurs between a series of traders in a supply chain associated with a common chain identifier. One or more embodiments may also include a vendor information memory unit that stores the set payment terms. Then, a computer performs a process to set the payment flag as “payable” for the plurality of billing information to which the credited billing information and the common chain identifier is assigned to, and a process to arrange payment for the billing information whose payment flag is “payable”, and which meets the payment conditions.

One or more embodiments may also be configured as follows. That is, the computer is provided with a ledger data memory that stores an accounting ledger for each vendor. After completion of the arranged payment, the computer records a journal entry for the payment in the accounting ledger of the payer of the completed payment and a journal entry for the deposit in the accounting ledger of the payee of the completed payment.

In the above, “accounting ledgers” include ledgers and vouchers. “Accounting ledgers” generally include journal entries, general ledgers, deposit and disbursement ledgers, accounts payable ledgers (supplier ledgers), accounts receivable ledgers (customer ledgers), etc. “Vouchers” generally include deposit/withdrawal slips, invoices, delivery slips, etc.

According to one or more embodiments, payments generated by transactions between multiple vendors may be automated. It may also automate the recording of ledgers related to payments between multiple vendors.

### BRIEF DESCRIPTION OF THE DRAWING

FIG. 1 is a diagram illustrating an overall configuration including a transaction management system.

FIG. 2 is a diagram illustrating a hardware configuration of each computer such as is illustrated in FIG. 1.

FIG. 3 is a diagram illustrating a flow diagram of an overall operation of a configuration such as is illustrated in FIG. 1.

FIG. 4 is a diagram illustrating a first configuration of a ledger updating unit included in a transaction management system such as is illustrated in FIG. 1.

FIG. 5 is a diagram illustrating a billing matching unit included in a transaction management system such as is illustrated in FIG. 1.

FIG. 6 is a diagram illustrating an allocating unit included in a transaction management system such as is illustrated in FIG. 1.

FIG. 7 is a diagram illustrating a transfer instruction unit included in a transaction management system such as is illustrated in FIG. 1.

FIG. 8 is a diagram illustrating a flow chart of a transfer instruction unit, as shown in FIG. 7.

FIG. 9 is a diagram illustrating a configuration of a ledger updating unit included in a transaction management system such as is illustrated in FIG. 1.

### DETAILED DESCRIPTION

Overall Configuration

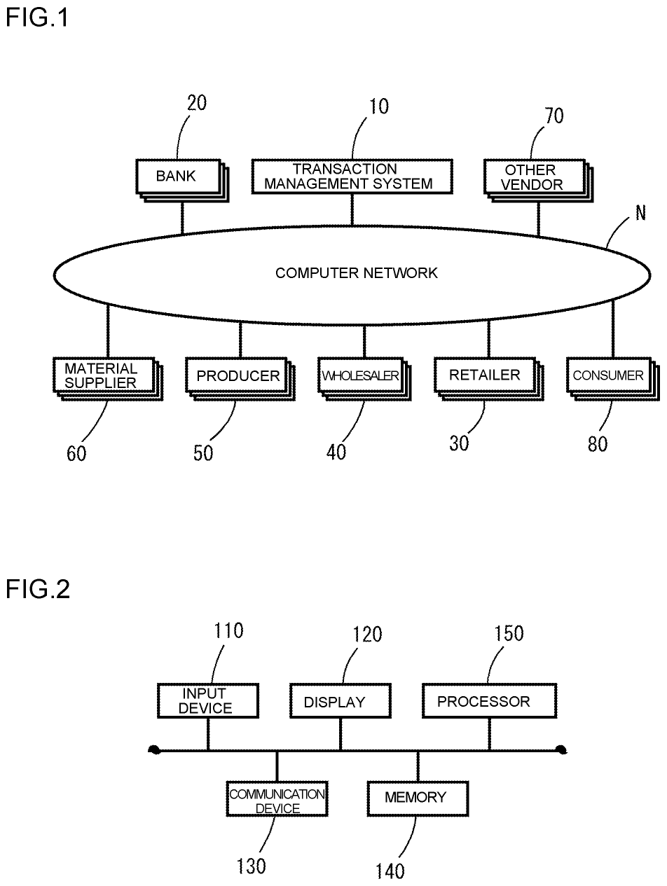

One or more embodiments is described below with reference to the drawings. In FIG. 1, the transaction management system 10 is connected via a computer network N to enable data communication with a plurality of vendors' and consumer computers 20 to 80. The multiple vendors include retailers, wholesalers, producers, material suppliers, banks, and other vendors involved in the transaction of goods. Hereafter, each of these vendors may be referred to collectively as the “transaction parties”.

Retailers provide goods to consumers. Wholesalers provide goods to retailers or consumers. Producers provide goods to wholesalers, retailers, or consumers. Material suppliers provide materials necessary for production or manufacture to producers. Among these, when the multiple vendors are involved in the provision of a certain commodity, payment among multiple vendors occurs. Conventionally, each vendor arranges payments individually, and each vendor records accounting ledgers related to payments on its own. One or more embodiments automates the arrangement of payments and the recording of accounting ledgers that occur among these multiple vendors.

There are a large number of each transaction party and consumer participating in this system, and a plurality of computers 20 to 80 of each participant and consumer are connected to the computer network N.

The transaction management system 10, as well as the computers 20 through 70 of each of the transaction parties and the consumer computer 80, basically adopt the general hardware configuration of a computer. That is, as shown in FIG. 2, the system includes an input device 110 such as a keyboard and a display device 120 such as a liquid crystal display. It also includes a communication device 130 such as NIC (a network interface card) that enables data communication between computers through a computer network N. Furthermore, it includes a memory 140 such as a memory that stores information necessary for computer processing, and a processor 150 such as a CPU (Central Processing Unit) that realizes various functions by executing a program.

Here, the appearance of the computer does not matter. It may be a server type, desktop type, notebook type, tablet type, portable terminal type, etc. It may also be a ledger of distributed computing with multiple computers.

Overall Operation

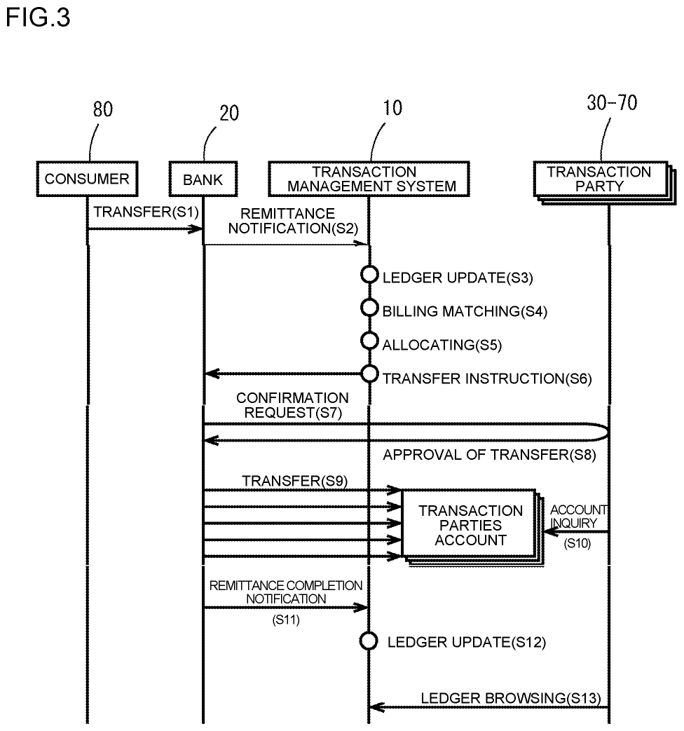

The flow of operation of the entire system is shown in FIG. 3. The operation of all computers 10 through 80, including the transaction management system 10, is realized by the processor 150 executing a predetermined program. A product involving several transaction parties is sold to a consumer, and the payment for the product is transferred from the consumer to a deposit account at a predetermined bank. The deposit account is the account of the operator of the transaction management system 10. Hereafter, the operator of the transaction management system 10 may be referred to simply as the “system operator”. That is, as shown in FIG. 3, first, the consumer computer 80 transfers the payment for the product to the bank computer 20, which transfers the payment for the product to the system operator's account managed by the bank (51).

The bank computer 20 receives the transfer and sends a notice of the remittance of the product price to the transaction management system 10 (S2).

Upon receipt of the remittance notification, the transaction management system 10 records the journal entry of this deposit in the system operator's ledger (ledger or voucher) through the process of the ledger updating unit described below (S3).

The transaction management system 10 searches for the billing information corresponding to the remittance notification and extracts the chain identifier contained in the corresponding billing information through the process of the billing matching unit described below (S4). A chain identifier is an identifier that uniquely identifies a set of vendors associated with a transferred bill. For example, each billing information among a series of retailers, wholesalers, producers, material suppliers, and other vendors involved in the provision of goods provided to consumers is automatically generated by the technique described in Patent Document 1, etc. above. The same chain identifier is associated and stored with each billing information among this series of vendors.

The transaction management system 10 then searches for multiple billing information associate with the same chain identifier as the extracted chain identifier through the allocating unit described below, and sets the payment flag of each applicable billing information as “payable” (S5).

Then, the transaction management system 10 instructs the bank computer 20 to transfer the amount of the billing information whose payment flag is “payable” to be paid each time or in aggregated base according to the payment terms set for each vendor through the transfer instruction unit described below (S6).

Upon receipt of the transfer instruction, the bank computer 20 sends a request for confirmation of the withdrawal to the computers 30 through 70 of the transaction parties who have the withdrawal accounts for the indicated transfer (S7).

Upon receipt of the confirmation request, the computers 30 through 70 of the transaction parties receive input of the transfer approval from the input device 110, and return the approval of the transfer to the bank computer 20 (S8). Here, the transfer approval may be entered automatically by the computers 30 through 70 of the transaction parties when predetermined payment terms are met. The predetermined conditions are, for example, the due date of the transfer, such as payment at the end of the month. When transfer approval input is performed automatically, the above transfer approval input (e.g., input operation) may not be required.

Upon receipt of the approval of the transfer from the computers 30 through 70 of the transaction parties, the bank computer 20 executes the approved transfers among the transfers that have been received transfer instructions in S6, addressed to the accounts of the internal or external transaction parties sequentially (S9).

In this way, the payment for goods transferred from the consumer is automatically allocated to multiple transaction parties and paid. Each of the transaction parties connect from its own computer 30 through 70 to the computer that manages the account of its own transaction parties and inquire about the deposit and withdrawal details and balances (S10).

The bank computer 20 sequentially sends a transfer completion notification to the transaction management system 10 for each completed transfer (S11).

Upon receipt of the remittance completion notification, the transaction management system 10 records the journal entry of the withdrawal on the ledger sheet of the vendor from whom the transfer is made and the journal entry of the deposit on the ledger sheet of the vendor to whom the transfer is made (S12) through the process of the ledger updating unit described below.

The computers 30 through 70 of the transaction parties may access their own accounting ledgers managed by the transaction management system 10 and view the contents of the ledgers (S13).

This process flow may automate the recording of payments and payment-related ledgers generated by transactions between multiple vendors.

Operation Details of Transaction Management System 10

Next, the operation of the transaction management system 10 described above is described in detail. The transaction management system 10 realizes the operation of the following parts by processor 150 executing the program.

Form Updating Unit (First Process)

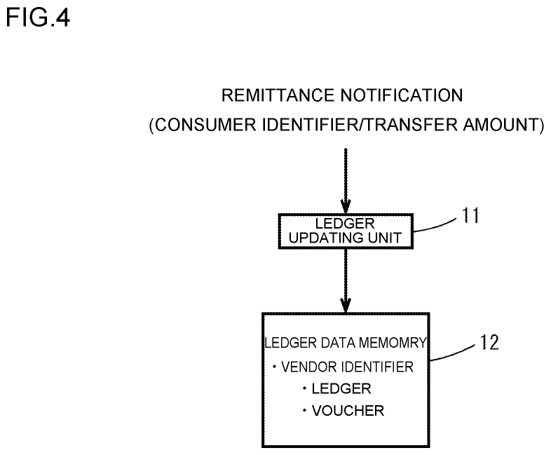

First, the process of the ledger updating unit 11 described in S3 is explained with reference to FIG. 4. The remittance notification received from the bank computer 20 includes at least the identifier of the consumer who made the transfer (consumer identifier) and the transfer amount. The consumer identifier may be the name or designation of the consumer or a code unique to each consumer.

On the other hand, the memory 140 of the transaction management system 10 has a ledger data memory 12. The ledger data memory 12 stores the data of accounting ledgers (ledgers and vouchers) of the vendor for each vendor identifier.

In the S3 process described above, the ledger updating unit 11 records the journal entry of the amount transferred from the consumer indicated in the remittance notification in the ledger linked to the system operator's vendor identifier.

Billing Matching Unit

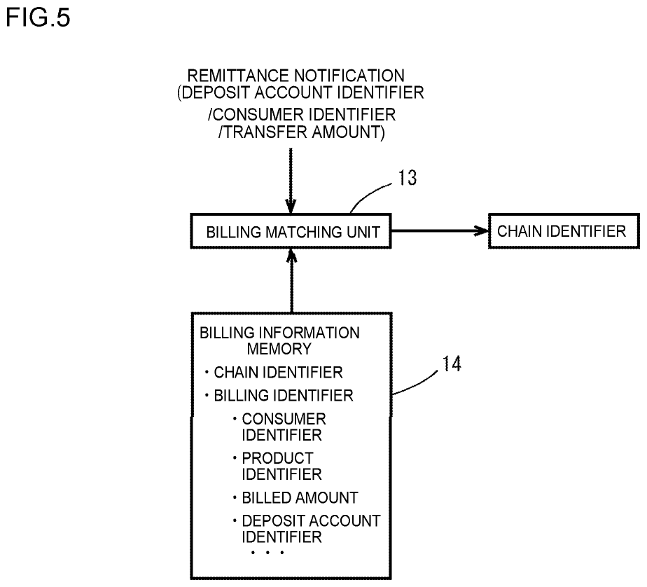

The process of the billing matching unit 13 described in S4 is then described with reference to FIG. 5. The remittance notification received from the bank computer 20 may include at least an identifier (consumer identifier) of the consumer (customer) who made the transfer, the amount of the transfer, and a deposit account identifier. The deposit account identifier is a transfer account number, or the like assigned for deposit for each invoice.

The memory 140 of the transaction management system 10 has a billing information memory 14. The billing information memory 14 stores, for each billing identifier, the chain identifier, consumer identifier, product identifier, billed amount, and if necessary, a deposit account identifier, etc., in association with each other. The billing information is recorded in the billing information memory 14 each time an invoice (invoice slip) is issued according to the previously described in Patent Document 1, etc. The billing identifier is a unique code for each invoice issued. The chain identifier is an identifier that uniquely identifies a group of vendors associated with a set of goods for this invoice. The consumer identifier is a unique name, designation or code for each consumer who purchased the goods. Although “consumer” is described here assuming a B to C transaction, the purchaser of the goods may be a vendor, and “consumer” may be replaced with “purchaser”. A product identifier is a unique code for each product. Even if the goods are the same, different product identifiers are assigned to goods with different transaction parties, or with different payment channels among transaction parties, or with different distribution of payment among transaction parties. In some cases, multiple product identifiers may be included in a single billing information.

The billing matching unit 13 searches the billing information memory 14 for a record of billing information that matches the consumer identifier and transfer amount indicated in the remittance notification. In addition, it may search the billing information memory 14 for a record of billing information that matches the deposit account identifier indicated in the remittance notification. If a record of matching billing information is found, the chain identifier contained in that record is extracted.

Allocating Unit

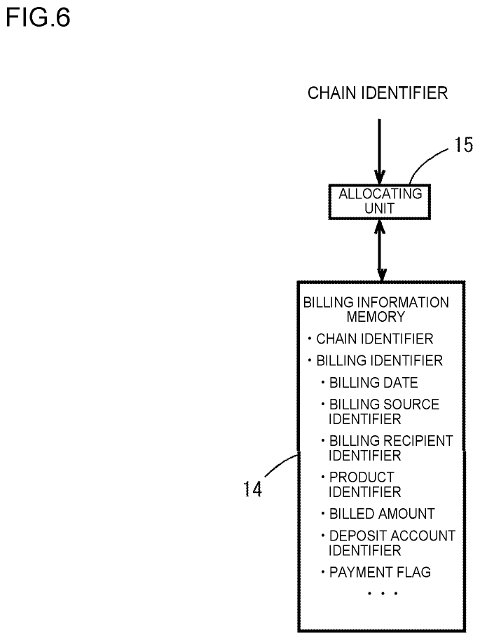

The process of the allocating unit 15 described in S5 is then explained with reference to FIG. 6. As mentioned above, the memory 140 of the transaction management system 10 has a billing information memory 14. In the billing information memory 14, billing information is recorded each time a series of invoices (invoice slips) are issued between vendors according to the technique of above-described patent document 1, etc. The billing information between each vendor is linked to a chain identifier, billing date, billing source identifier, billing recipient identifier, product identifier, billed amount, deposit account identifier, and payment flag for each billing identifier. The billing source identifier is the vendor identifier of the vendor who is the billing source (payee). The billing recipient identifier is the vendor identifier of the vendor who is billed to (payer). To give an example of a series of invoices between vendors, for example, when 10,000 yen is transferred for a product with a certain product identifier, the system operator receives 500 yen and pays 8,400 yen from the system operator to retailer A. Retailer A pays 6,000 yen to producer B, and producer B pays 2,000 yen to material supplier C. The system operator pays 100 yen to bank D and 1,000 yen to other vendor E. This kind of allocation of money among the transaction parties is made in the billing information among the vendors who share the same chain identifier. Here, the other vendor E may be any party involved in the transaction, such as a TV station or affiliate site that introduced the product. The vendor identifier is the name of the vendor or a unique code for each vendor. Bank D is the bank indicated by the code 20 in FIG. 3 and receives payment in exchange for processing in conjunction with the transaction management system 10.

The allocating unit 15 searches the billing information memory for multiple billing information having the same chain identifier as the chain identifier output by the billing matching unit 13, and sets the payment flag of each applicable billing information to “payable” to indicate that the information is eligible for payment. The payment flag has the value of “not paid”, “payable” or “paid”.

Transfer Instruction Unit

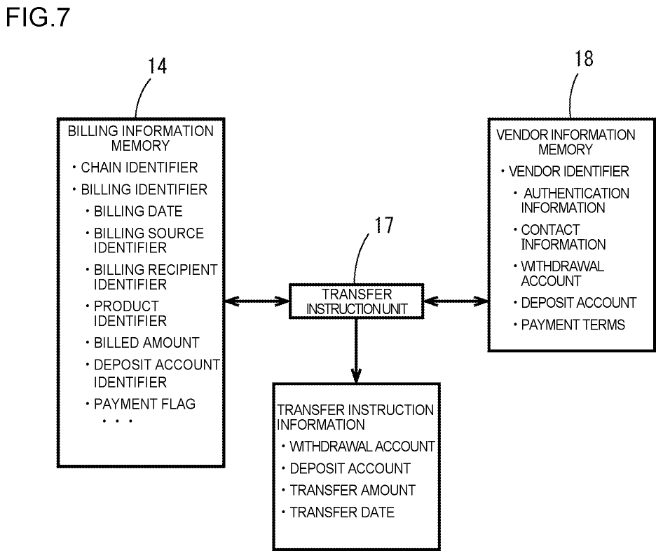

The process of the transfer instruction unit 17 described in S6 is then explained with reference to FIG. 7. The vendor information memory 18 is provided in the memory 140 of the transaction management system 10. The vendor information memory 18 stores authentication information, contact information, withdrawal account, deposit account, and payment conditions linked to each vendor identifier. The authentication information is the user ID and password used when the vendor logs into the transaction management system 10 to view the ledger sheet, etc. The contact information is the email address and so on of the vendor. Contact information is the contact information, such as the email address of the relevant vendor. Withdrawal account is the account number of the vendor when the vendor is the payment source. The deposit account is the account number of the vendor when the vendor is the payee. Payment terms are the payment terms when the vendor is the payment source. The payment terms may include each time payment or payment that close at the end of the month and pay at the end of the following month, and so on.

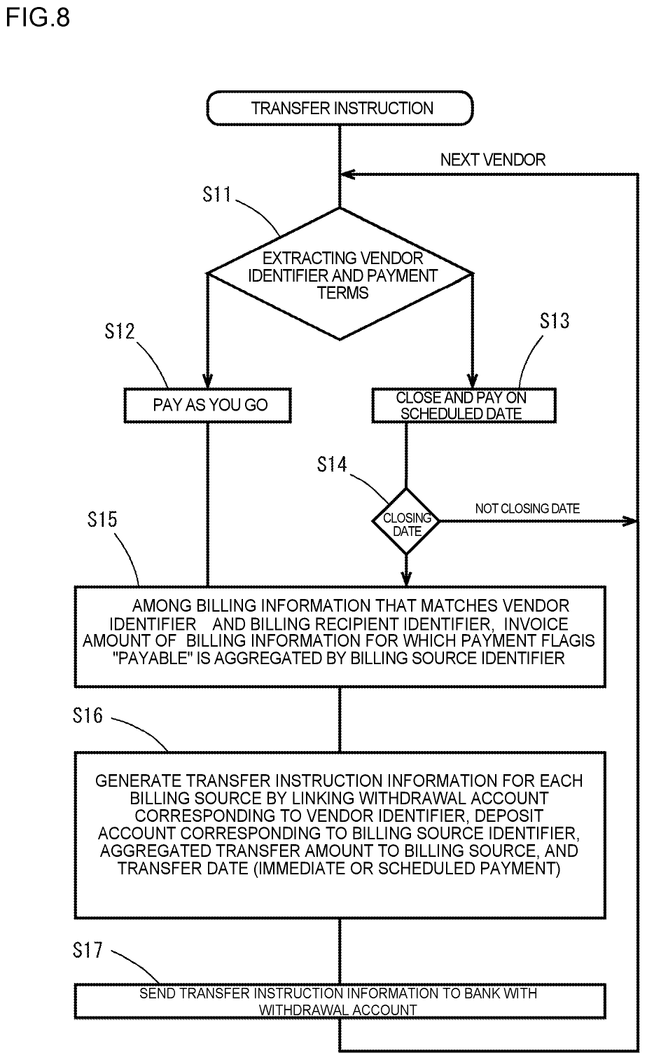

The transfer instruction unit 17 performs the process shown in FIG. 8. First, one vendor identifier and the payment condition associated with it are read from the vendor information memory 18 (S11). If the payment condition is payment each time payment is received (S12), the process proceeds to S15. If the payment condition is for payment on a certain date with the certain close date (S13), the system determines whether the relevant closing date has arrived (S14), and if the closing date has arrived, it proceeds to S15. If the closing date has not arrived, the process is repeated from S11 for the next vendor.

When the date of each payment or closing date has arrived, the billing information whose payment flag is “payable” is read from the billing information memory 14 among the billing information whose vendor identifier matches the billing recipient identifier being processed, and the billed amounts of the read billing information are aggregated for each billing source identifier (S15).
Next, the system links the withdrawal account corresponding to the vendor identifier being processed, the deposit account corresponding to the billing source identifier, the aggregated transfer amount to the relevant billing source, and the transfer date, and generates transfer instruction information for each billing source (S16). The transfer date is set to be the same day in the case of payment each time payment is received, or a certain date in the case of payment on a certain date with a certain closing date. The transfer instruction unit 17 then sends the generated transfer instruction information to the bank computer 20 where the withdrawal account is located. Thereafter, the next vendor is selected and the process from S11 is repeated. The transfer instruction unit 17 changes the payment flag of the billing information subject to the transfer instruction to “paid”. As described above, the ledger of payment may automate payments generated by transactions between multiple vendors.

Ledger Updating Unit (Second Process)

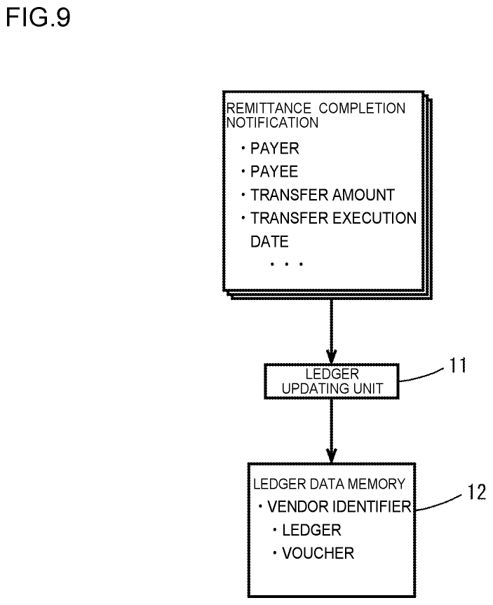

The process of the ledger updating unit 11 described in S12 is then explained with reference to FIG. 9. Based on the transfer instructions from the transfer instruction unit 17, the bank computer 20 that completes the transfer returns multiple remittance completion notifications to the transaction management system 10. Each transfer completion notice includes at least the vendor identifier of the payer, the vendor identifier of the payee, the transfer amount, and the transfer execution date. The ledger updating unit 11 extracts these information from the remittance completion notification and records the journal entry of the payment on a ledger in the ledger data memory 12 associated with the vendor identifier of the payment source as payment information. The journal entry for the payment is recorded in the ledger sheet in the ledger data memory 12 associated with the vendor identifier of the payee as the payment information. For each remittance completion notification, a journal entry for deposit or payment is recorded in the ledger sheets of each party involved in the transaction.

That is, when a payment is made, the amount received is automatically entered in the sales ledger and displayed on the computer screen, the amount received is subtracted from the unpaid balance, and the new balance is displayed in the on-screen ledger. On the side that made the payment, the system records the date, amount, and details of the payment, automatically enters them in the purchase ledger, subtracts the amount from the previous unpaid balance, calculates a new unpaid balance, and displays them in the purchase ledger on the screen. If a transfer fee is charged, the amount received and the transfer fee charged are subtracted, and the balance after the transfer is calculated and displayed on the screen. In addition, the same process is performed not only on the payment side but also on the deposit side.

In this way, accounting ledgers are automatically recorded for each party involved in the transaction. Here, the processing contents on the deposit side and the payment side are all the same, such as amount, item name, unit price, quantity, etc., and are in a front-and-back relationship. Therefore, the same contents (data) may be displayed on the screen in a front-and-back relationship. However, even in this case, the word “received” on the deposit side is displayed as “paid” on the payment side.

Variations

The aforementioned “payment condition” may be “payment of the invoice amount from the billing recipient to our company”. For example, suppose that the billing information with the same chain identifier is a billing of p yen from Company A to Company B, a billing of q yen from Company C to Company B, and a billing of r yen from Company B to Company D. In this case, when r yen is transferred from D to Company B, the payment conditions from Company B to Company A and from Company B to Company C are satisfied. As a result, company B automatically transfers q yen to company A, and company B automatically transfers p yen to company C. The transfer fee is recorded in each company's journal by being displayed in the aforementioned remittance completion notification.

Thus, for example, when a retailer receives a payment of 10,000 yen for a product from a consumer, the retailer automatically transfers 6,000 yen of the purchase price to the supplier and also automatically transfers 500 yen of the system fee to the system operator, and a series of payment processes maybe automated. The system may also automate the recording of each company's transactions, including transfer fees.

Here, the scope of the invention is within the scope of the composition requirements described in the claims, and is not limited to the above embodiments.

1. A transaction management method for a system comprising a billing information memory that stores a plurality of related billing information that occur between a series of vendors by supply chain in association with a common chain identifier, and a vendor information memory that stores vendor information,
the billing information memory stores at least the chain identifier, a billing source identifier, a purchaser identifier or a billing recipient identifier, and a billing amount as the billing information, which are associated with each other in the billing information memory,
the vendor information memory stores at least a vendor identifier, withdrawal account information, deposit account information, which are associated with each other in the vendor information memory,
a computer performs operations comprising:
searching the billing information corresponding to the purchaser identifier and a deposit amount indicated in a received deposit notification from the billing information memory;
extracting a chain identifier included in the searched billing information;
setting payment flags of a plurality of billing information including a chain identifier that is common to the extracted chain identifier as payable;
reading the billing source identifier, the billing recipient identifier, and the billing amount from the billing information which the payment flags are set to payable;
reading the deposit account information associated with the vendor identifier corresponding to the read billing source identifier, and the withdrawal account information associated with the vendor identifier corresponding to the read billing recipient identifier from the vendor information memory;
generating transfer instruction information including the deposit account information, the withdrawal account information and a transfer amount based on the billing amount; and
sending the instruction information to a computer of a financial institution that manages the withdrawal account.

2. The transaction management method according to claim 1, wherein
the system further comprises a ledger data memory that stores the vendor identifier of each of the vendors and an accounting ledger information of each vendor, which are associated with each other,
the computer further performs operations comprising:
after receiving a remittance completion notification corresponding to the instruction information, recording a journal entry for a withdrawal in the accounting ledger information associated with the vendor identifier of the vendor that the completed transfer was requested; and
recording the journal entry for a deposit in the accounting ledger information associated with the vendor identifier of the vendor that is the billing source of the remittance completed.

3. A transaction management system comprising:
a billing information memory that stores a plurality of related billing information that occurs between a series of vendors by supply chain in association with a common chain identifier, the billing information memory stores at least the chain identifier, a billing source identifier, a purchaser identifier or a billing recipient identifier, and a billing amount as the billing information, which are associated with each other in the billing information memory;
a vendor information memory that stores vendor information, the vendor information memory stores at least a vendor identifier, withdrawal account information, deposit account information, which are associated with each other in the vendor information memory; and
a computer that performs operations comprising:
searching the billing information corresponding to a purchaser identifier and a deposit amount indicated in a received deposit notification from the billing information memory;
extracting a chain identifier included in the searched billing information;
setting payment flags of a plurality of billing information including a chain identifier that is common to the extracted chain identifier as payable;
reading the billing source identifier, the billing recipient identifier, and the billing amount from the billing information for which the payment flag is set to payable;
reading the deposit account information associated with the vendor identifier corresponding to the read billing source identifier, and the withdrawal account information associated with the vendor identifier corresponding to the billing recipient identifier from the vendor information memory;
generating transfer instruction information including the deposit account information, the withdrawal account information and a transfer amount based on the billing amount; and
sending the instruction information to a computer of a financial institution that manages the withdrawal account.

4. The transaction management system according to claim 3, further comprising
a ledger data memory that stores the vendor identifier of each of the vendors and an accounting ledger information of each vendor, which are associated with each other, wherein
the computer further performs operations comprising:
after receiving a remittance completion notification corresponding to the instruction information, recording a journal entry for the withdrawal in the accounting ledger information associated with the vendor identifier of the vendor that the completed transfer is requested; and
recording the journal entry for the deposit in the accounting ledger information associated with the vendor identifier of the vendor that is the billing source of the completed transfer.

5. A transaction management program for a system comprising a billing information memory that stores a plurality of related billing information that occurs between a series of vendors by supply chain in association with a common chain identifier, and a vendor information memory that stores vendor information,
the billing information memory stores at least the chain identifier, a billing source identifier, a purchaser identifier or a billing recipient identifier, and a billing amount as the billing information, which are associated with each other in the billing information memory,
the vendor information memory stores at least a vendor identifier, withdrawal account information, deposit account information, which are associated with each other in the vendor information memory,
the program causes a computer to perform operations comprising:
searching the billing information corresponding to the purchaser identifier and a deposit amount indicated in a received deposit notification from the billing information memory;
extracting a chain identifier included in the searched billing information;
setting payment flags of a plurality of billing information including a chain identifier that is common to the extracted chain identifier as payable;
reading the billing source identifier, the billing recipient identifier, and the billing amount from the billing information which the payment flags are set to payable;
reading the deposit account information associated with the vendor identifier corresponding to the read billing source identifier, and the withdrawal account information associated with the vendor identifier corresponding to the read billing recipient identifier from the vendor information memory;
generating transfer instruction information including the deposit account information, the withdrawal account information and a transfer amount based on the billing amount; and
sending the instruction information to a computer of a financial institution that manages the withdrawal account.

6. The transaction management program according to claim 5, wherein
the system further comprises a ledger data memory that stores the vendor identifier of each of the vendors and an accounting ledger information of each vendor, which are associated with each other,
the program causes the computer to further perform operations comprising:
after receiving a remittance completion notification corresponding to the instruction information, recording a journal entry for a withdrawal in the accounting ledger information associated with the vendor identifier of the vendor that the completed transfer was requested; and
recording the journal entry for a deposit in the accounting ledger information associated with the vendor identifier of the vendor that is the billing source of the remittance completed.
